(19) United States
(12) Patent Application Publication
(10) Pub. No.: US 2006/0202494 A1
(43) Pub. Date: Sep. 14, 2006

(54) Combination spatula and tong device for handling food

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/371,088

(22) Filed: Mar. 9, 2006

Related U.S. Application Data
(60) Provisional application No. 60/659,421, filed on Mar. 9, 2005.

(51) Int. Cl. A47J 43/28

(52) U.S. Cl. 294/7

(57) ABSTRACT

A cooking utensil for handling food including an elongate handle member having a first end and an opposite second end, a generally flat spatula member provided on the second end of the elongate handle member, the spatula member having a first side edge generally opposed to a second side edge, wherein the first side edge having a tenderizing means, and a grasping member pivotally connected to the elongate handle member proximate to the second end, the grasping member adapted to bias toward the spatula for engaging and grasping the food.

### PRIOR APPLICATION

This application claims the benefit of U.S. Provisional Application Ser. No. 60/659,421, filed Mar. 9, 2005, entitled FLIPPER GRIPPER DEVICE.

### FIELD OF THE INVENTION

The invention relates to cooking utensils, and more particularly to combination spatula and tong device for handling food

### BACKGROUND OF THE INVENTION

Outdoor barbequing is an increasingly popular cooking technique which produces food, such as steaks, chicken and vegetables, having unique flavors and textures which cannot be easily duplicated in a traditional kitchen. During the preparation of a meal which involves the searing and grilling of food on a barbeque, the barbeque user often must use several cooking utensils to reposition the food on the barbeque grill or transfer the cooked food to the plates of the guests. Most barbeque users have at least a half dozen individual cooking utensils that they regularly use when barbequing. When barbequing irregularly shaped food, such as corn, sausages and potatoes, the barbeque user often must use two or more cooking utensils to safely and securely transfer the food to a plate. For example, when transferring a piece of steak and corn, the barbeque user may utilize a spatula and tongs, respectively. Given the limited amount of space on barbeques to store these utensils, it often occurs that the barbeque user must step away from the barbeque to locate the appropriate utensil(s) for each of these purposes. During which time the food may overcook or become adhered to the surface of the barbeque grill making it more difficult for the barbeque user to transfer these food from the barbeque. Moreover, the use of several cooking utensils may result in the barbeque user accidentally burning their hand, wrist or arm on the barbeque when searching for the appropriate utensil. Dropping one or more of these individual utensils may also result in considerable damage to the cooking surface of the barbeque grills and the heating element within the barbeque.

Accordingly, there is a need for a cooking utensil for use when barbequing consisting of a spatula member and a grasping member for engaging food on a barbeque. There is a further need for a cooking utensil having a serrated edge for engaging and restricting the movement of the food engage between the spatula member and the grasping member. There is also a need for a cooking utensil having an elongate handle member that maintains the barbeque user's hands and wrists at a safe distance form the grill when barbequing.

### SUMMARY OF THE INVENTION

The present invention is directed to a cooking utensil for handling food including an elongate handle member having a first end and an opposite second end, a generally flat spatula member provided on the second end of the elongate handle member, the spatula member having a first side edge generally opposed to a second side edge, wherein the first side edge having a tenderizing means, and a grasping member pivotally connected to the elongate handle member proximate to the second end, the grasping member biasing toward the spatula for engaging and grasping the food. The grasping member having a grasping portion and a hand portion, the grasping portion being adapted for engaging and grasping the food, the hand portion being adapted to pivotally move the grasping portion from an engaged position to a disengaged position. The grasping portion having a contoured upper surface and a pair of serrated side edges for engaging and grasping the food in an engaged position. The grasping member including a pair of spaced pivot flanges at a midpoint thereof, wherein the pair of spaced pivot flanges being pivotally connected to the elongate handle member about a pivot means. The pivot means including a torsion spring and a pivot pin, the pivot pin being inserted through the pair of spaced pivot flanges and the torsion spring. The torsion spring between the grasping member and the elongate handle member continuously urges the grasping member towards the spatula member. The tenderizing means is integrally formed with the spatula member, and may include a plurality of teeth extending from and generally along the second side edge of the spatula member.

The first end of the elongate handle member is provided with a heat-resistant sleeve. The first end of the elongate handle member is provided with a hook means. The handle member, the grasping member, and the spatula member are made of a metallic material or polypropylene. The first end of the elongate handle member may be disposed in an offset alignment to the second end thereof.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a cooking utensil made in accordance with a preferred embodiment of the invention;

FIG. 2 is a side elevation view of the cooking utensil of FIG. 1 in an engaged position;

FIG. 3 is a side elevation view of the cooking utensil of FIG. 1 in a disengaged position;

FIG. 4 is a perspective view of the cooking utensil of FIG. 1 showing the contoured upper surface and side edges of the grasping member; side elevation view of the multi-purpose cooking utensil of FIG. 1;

FIG. 5 is a cross-sectional plan view of the pivot means of the cooking utensil of FIG. 1.

FIG. 6 is a cross-section side view of the pivot means of the cooking utensil of FIG. 1.

### DETAILED DESCRIPTION OF THE INVENTION

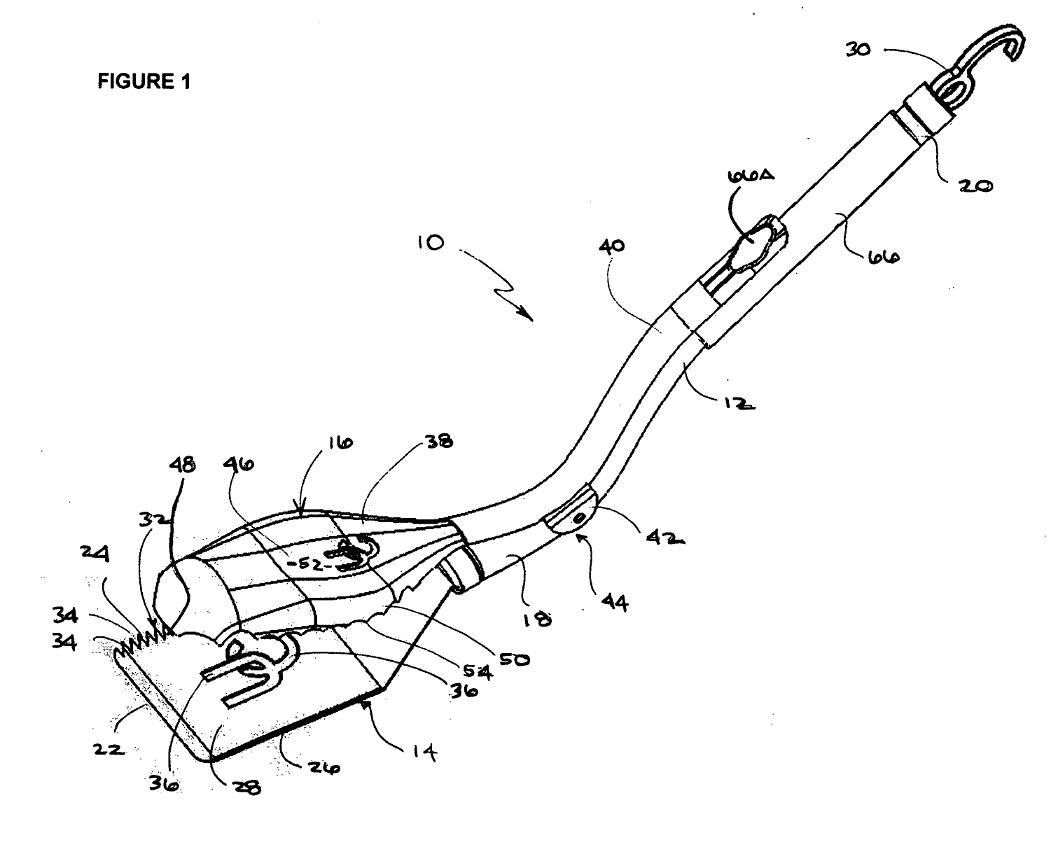

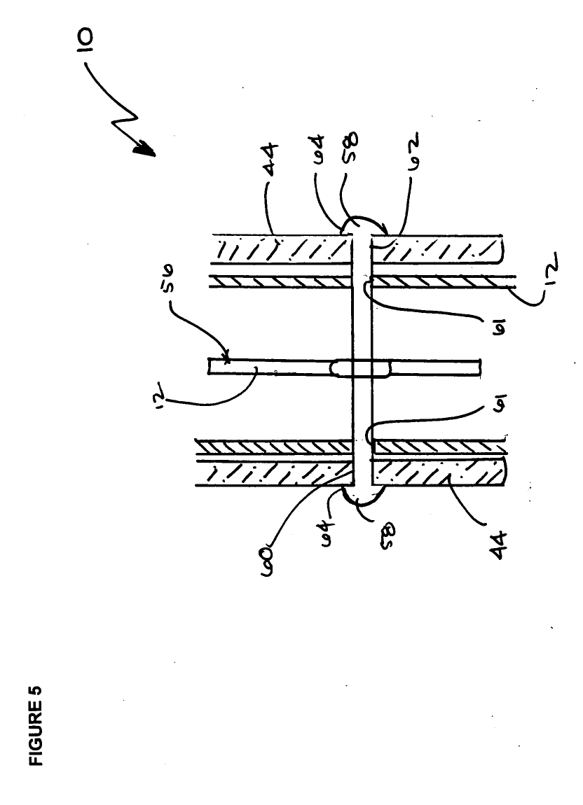

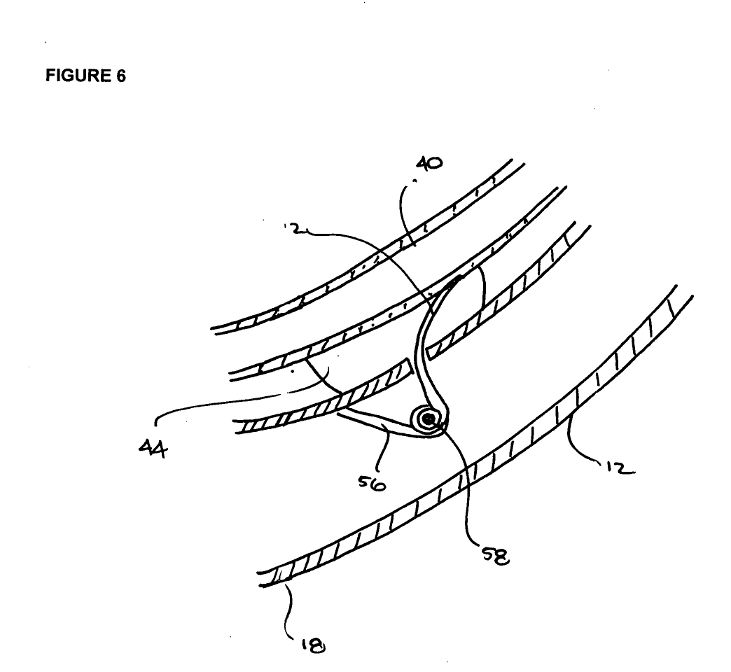

Reference is made to FIGS. 1, 2, 3, 4, 5 and 6 which illustrate a cooking utensil 10 for use when barbequing made in accordance with a preferred embodiment of the present invention. The cooking utensil 10 has an elongate handle member 12, a generally flat spatula member 14 and a tong or grasping member 16. The elongate handle member 12 having a first end 18 and an opposite second end 20. The generally flat spatula member 12 is provided on the second end 20 of the elongate handle member 12, and includes a front edge 22, a first side edge 24, and a second side edge 26 generally opposed to the first side edge 24. The front edge 22, the first side edge 24, and the second side edge 26 generally defining a food support surface 28. The first end of the elongate handle member 12 may have an optional hook means 30 to allow the cooking utensil 10 to be attached to a barbeque or the barbeque user's belt.

Referring to FIGS. 1, 2 and 3, the first edge 24 of the spatula member 14 is formed with a tenderizing means 32. The tenderizing means 32 may be integrally formed with the spatula member 14. The tenderizing means 32 has a plurality of sharp teeth 34 that extend from and generally along the first side edge 24 of the spatula member 14. The teeth 34 are generally triangular-shaped and are adapted to pierce and tenderize at least a surface portion of the food. The teeth 34 of the tenderizing means 32 may also be used by the barbeque user to puncture holes in the surface of food, such as sausages and wieners, so as to allow the juices to escape and the seasonings to permeate the food. Additionally, teeth 34 of the tenderizing means 32 are adapted to enable the barbeque user to use the cooking utensil 10 to engage and drag the food on the grill of the barbeque.

The front edge 22 of the spatula member 14 is generally perpendicular to the side edges 24 and 26, and is designed to be easily inserted beneath the one or more foods cooking on the barbeque. The food support surface 28 may be formed with one or more apertures 36 that permit the flow through of juices or other liquids from the food when supported on the spatula member 14. It should be understood that the one or more apertures 36 may have any suitable shape and/or configuration on the food support surface 28 as is known in the art.

In a preferred embodiment of the present invention shown in FIGS. 1, 2, 3 and 4, the grasping member 16 is pivotally connected to the elongate handle member 12 proximate to the second end 20 for engaging and grasping the food on the grill of a barbeque. The grasping member 16 includes a grasping portion 38, a handle portion 40, and a pair of spaced pivot flanges 42 which couple the grasping member 16 to the elongate handle member 12 about a pivot means 44. The grasping portion 38 has a contoured upper surface 46, a front edge 48 and a pair of side edges 50. The contoured upper surface 46 being preferably shaped to enable the cooking utensil 10 to be used to securely grasp a wide variety of food, such as steaks and sausages, from the grill of a barbeque. For example, the contoured upper surface 46 may be provided with a domed mid-portion 52 that is designed to enable the engaging and grasping of baked potatoes between the contoured upper surface 52 of the grasping portion 38 and the food support surface 28 of the spatula member 14.

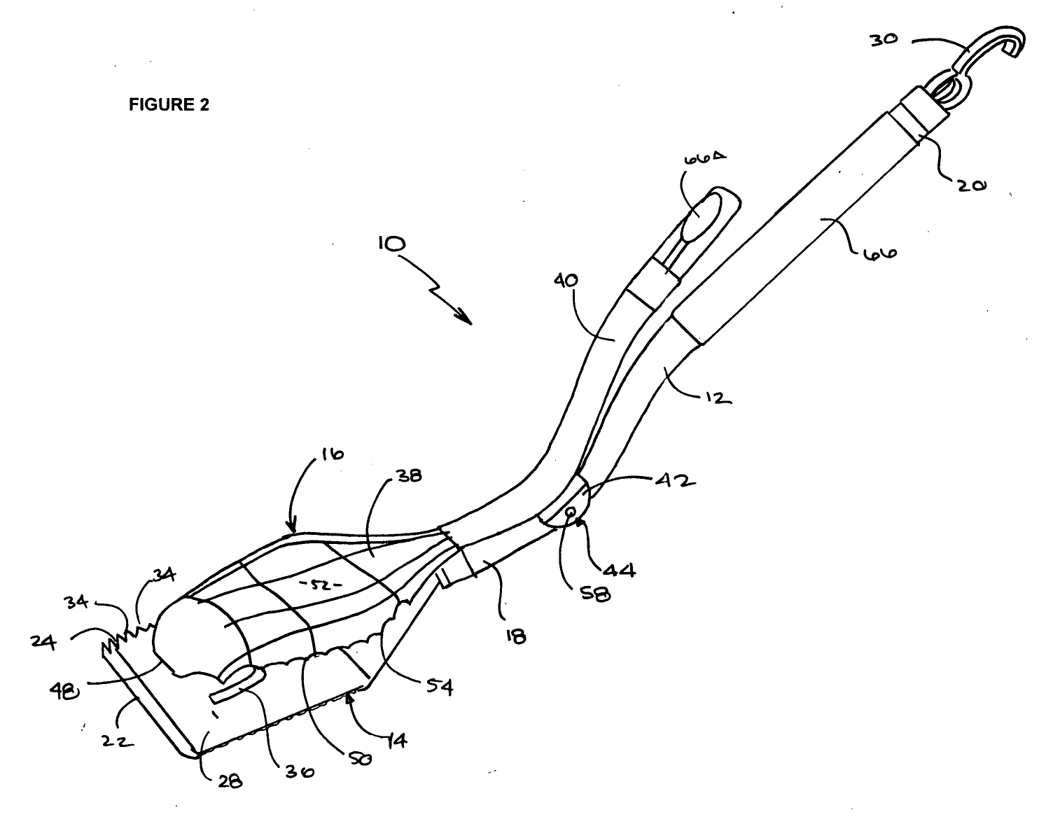

A plurality of serrations 54 extended generally downwardly from the contoured upper surface 52 substantially along the front and side edges 48 and 50 of the grasping portion 16. The serrations 54 are generally triangular-shaped and are designed to engage with food on the food support surface 28. Referring to FIG. 2, the serrations 54 may be sized to receive and engage with different shapes and sizes of food to prevent the food from slipping or sliding out between the grasping portion 38 and food support surface 28. For example, one or more enlarged serrations 54A may be provided adjacent to the front edge 48 of the grasping portion 38 may be used to engage corn or sausages. Similarly, one or more smaller serrations 54B may be provided along the side edges 48 and 50 of the grasping portion 38 for engaging with pieces of steak.

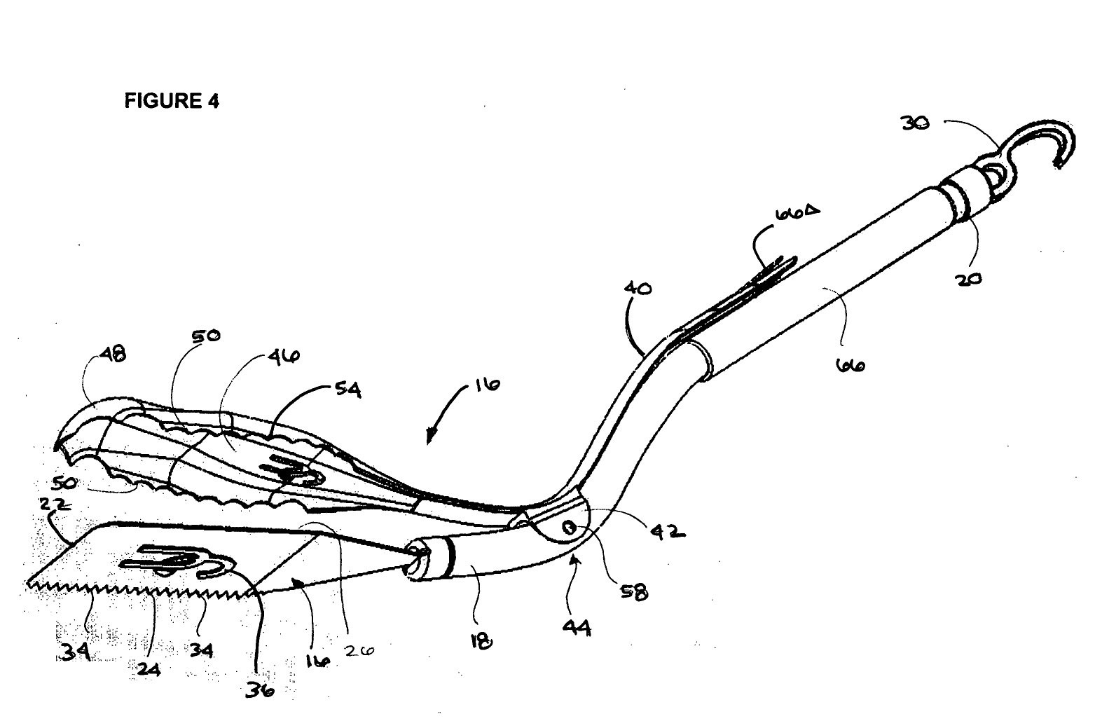

Referring to FIGS. 4, 5 and 6, the handle portion 40 is adapted to move the grasping portion 38 of the grasping member 16 about the pivot means 44 from an engaged position to a disengaged position. The pivot means 44 including a torsion spring 56 and a pivot pin 58. The torsion spring 56 is partially disposed within the elongate member 12. Pivot openings 60 provided in the pivot flanges 44 of the grasping member 16 are positioned alongside and aligned with a transverse opening 61 provided through the elongate member 12 proximate to the second end 20 thereof. The pivot pin 58 having lip portions 64 extends through the aligned openings 60 and 62 in the pivot flanges 44 and the elongate member 12 to connect the grasping member 16 to the elongate member 12 for pivotal movement. The torsion spring 56 has an arm 64 which extends from the elongate member 12 to engage the handle portion 40 of the grasping member 16 to continuously urge the grasping member 16 into an engaged position.

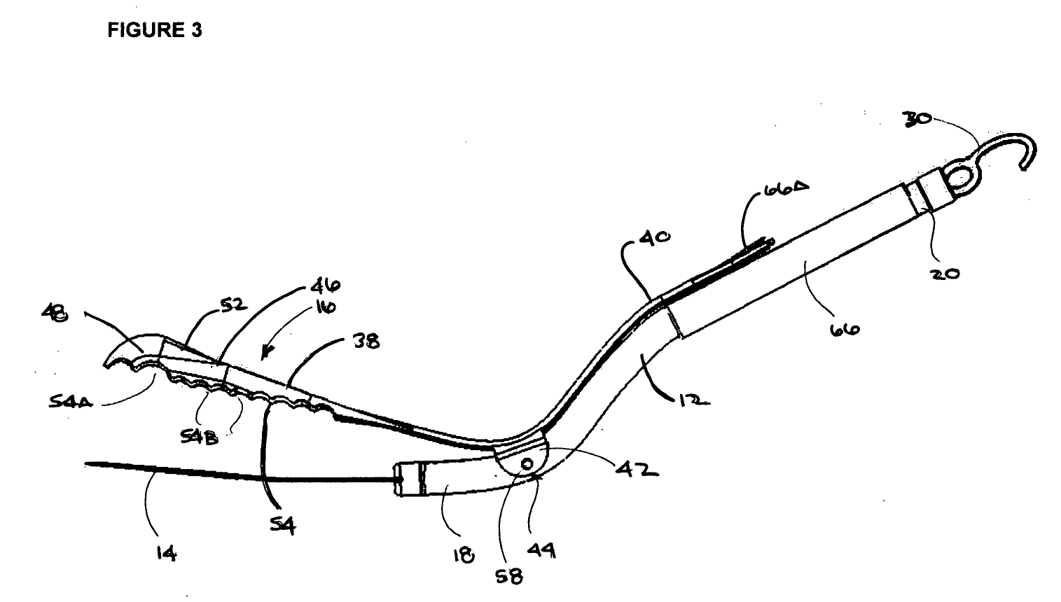

As shown in FIG. 2, in the engaged position, the grasping portion 38 of the grasping member 40 is urged toward the food support surface 28 of the spatula member 14. To position the cooking utensil 10 in the disengaged position, such as when transferring food from the cooking utensil 10 to a plate, the barbeque user simply depresses the handle portion 40 of the grasping member 16 in the direction A, as shown in FIG. 3

In a further embodiment of the present invention, the first end 18 of the elongate handle member 12 and the handle portion 40 of the grasping member 16 may be provided with a heat-resistant sleeve 66 to minimize the transmission of heat from the cooking utensil 10 to the hand of the barbeque user. The grasping member 40 may similarly be provided with a heat resistant thumb portion 66A. The heat-resistant sleeve and thumb portion 66 and 66A, respectively, may be made of any suitable material, such as, for example, rubber or polypropylene. It should be understood that the elongate handle member 12, the spatula member 14, and the grasping member 16 may be manufactured from any suitable material known by persons skilled in the art. For example, the spatula member 14 and the grasping member 16 may be manufactured from a metallic material, such as stainless steel or any steel material that may be appropriately formed and used as tenderizing means. It should be understood that the length of the elongate handle member 12 should be sufficient to ensure that the hands and arms of the barbeque user are a safe distance away from the barbeque. Moreover, the first end 18 of the elongate handle member 12 may be disposed in an offset alignment to the second end 20 thereof to further distance the hands and arms of the barbeque user from the hot surface of the barbeque grill.

The present invention has been described with regard to specific embodiments. However, it will obvious to persons skilled in the art that a number of variants and modifications can be made without departing from the scope and spirit of the invention, the scope of which is defined in the appended claims.

1. A cooking utensil for handling food, the cooking utensil comprising:
an elongate handle member having a first end and an opposite second end; and
a generally flat spatula member provided on the second end of the elongate handle member, the spatula member having a first side edge generally opposed to a second side edge, wherein the first side edge having a tenderizing means; and
a grasping member pivotally connected to the elongate handle member proximate to the second end, the grasping member biasing toward the spatula for engaging and grasping the food.

2. The cooking utensil as claimed in claim 1, wherein the grasping member having a grasping portion and a hand portion, the grasping portion being adapted for engaging and grasping the food, the hand portion being adapted to pivotally move the grasping portion from an engaged position to a disengaged position.

3. The cooking utensil as claimed in claim 4, wherein the grasping portion having a contoured upper surface and a pair of serrated side edges for engaging and grasping the food in an engaged position.

4. The cooking utensil as claimed in claim 1, the grasping member including a pair of spaced pivot flanges at a midpoint thereof, wherein the pair of spaced pivot flanges being pivotally connected to the elongate handle member about a pivot means.

5. The cooking utensil as claimed in claim 4, wherein the pivot means including a torsion spring and a pivot pin, the pivot pin being inserted through the pair of spaced pivot flanges and the torsion spring.

6. The cooking utensil as claimed in claim 5, wherein the torsion spring between the grasping member and the elongate handle member continuously urges the grasping member towards the spatula member.

7. The cooking utensil as claimed in claim 1, wherein the tenderizing means is integrally formed with the spatula member.

8. The multi-purpose cooking utensil as claimed in claim 1, wherein the tenderizing means includes a plurality of teeth extending from and generally along the second side edge of the spatula member.

9. The multi-purpose cooking utensil as claimed in claim 1, wherein the first end of the elongate handle member is provided with a heat-resistant sleeve.

10. The multi-purpose cooking utensil as claimed in claim 1, wherein the handle member, the grasping member, and the spatula member are made of a metallic material.

11. The multi-purpose cooking utensil as claimed in claim 1, wherein the handle member, the grasping member, and the spatula member are made of polypropylene.

12. The multi-purpose cooking utensil as claimed in claim 1, wherein the first end of the elongate handle member is provided with a hook means.

13. The multi-purpose cooking utensil as claimed in claim 1, wherein the first end of the elongate handle member is disposed in an offset alignment to the second end thereof.
